(19) United States
(12) Patent Application Publication
(10) Pub. No.: US 2012/0046917 A1
(43) Pub. Date: Feb. 23, 2012

(54) WIND ENERGY FORECASTING METHOD WITH EXTREME WIND SPEED PREDICTION FUNCTION

(76) Inventors: Hsin-Fa FANG, Hsinchu County (TW); Ing-Jane Chen, Taipei City (TW)

(21) Appl. No.: 13/161,828

(22) Filed: Jun. 16, 2011

(30) Foreign Application Priority Data
Aug. 23, 2010 (TW) 099128145

(51) Int. Cl. G06G 7/57; G06G 7/64; G06F 17/10

(52) U.S. Cl. 703/1

(57) ABSTRACT

A wind energy forecasting method with extreme wind speed prediction function cooperated with a central computer, comprising the steps of: inputting a weather data which contains a numerical weather prediction data; implementing a modification with a first model output statistics; implementing a modification with a physical model in accordance with the output of the first model output statistics that can iteratively calculate the results by varying the angles of wind direction; implementing a modification with a second model output statistics; and implementing a prediction of extreme wind speed caused by typhoon, which comprises the following sub-steps of: using a wind and typhoon database to find track data of plural historical typhoons within a certain distance from a target typhoon; using an extreme wind and wind energy prediction tool to calculate at least one extreme wind speed in the future of the target typhoon and calculate the probability of occurring the extreme wind speed; and modifying the extreme wind speed with the physical model to the extreme wind speed at the position or height of a wind turbine.

### CROSS REFERENCE TO RELATED APPLICATIONS

This Non-provisional application claims priority under 35 U.S.C. §119(a) on Patent Application No(s). 099128145 filed in Taiwan, Republic of China on Aug. 23, 2010, the entire contents of which are hereby incorporated by reference.

### BACKGROUND OF THE INVENTION

1. Field of Invention

The invention relates to a wind energy forecasting method with extreme wind speed prediction function.

2. Related Art

Due to the problems of energy deficiency, global warming and serious climatic changes, using renewable resources for power generation has become the proper solution to the problems. Renewable resources include wind energy, solar energy, biomass energy, geothermal energy, etc. Because of lower cost and high economic effect, wind power generation has been developed rapidly in the past few years.

In general, a wind power generator includes an impeller, a gearbox, a power generator, a shifting apparatus and a controlling system. The impeller has a set of blades well designed by fluid dynamics and installed to the axle. When wind passes through the blades, the impeller can be forced to rotate, resulting in kinetic power that is transmitted through the transmission system and gearbox to the power generator to generate electricity. The controlling system can control the shifting apparatus according to the wind direction signal from the wind direction sensor, so that the wind power generator can automatically maintain the proper orientation against the wind to optimize the power generation efficiency.

Strong and predictable output of wind energy is the primary requisite to develop wind power generation. However, the wind as the source of the wind power generation is naturally generated and unstable, so a well developed wind energy prediction system is needed to improve the usage of wind power generation and keep the security of power supply system.

In practical operations, the short-term wind energy forecasting can predict and follow the output variations of wind power generation at the wind farms within 48 hours in the future, which can increase the electricity output of the wind farm. For purpose of maintenance, the prediction with a longer scale is used to determine the timing of maintenance so that the cost of power generation business can be lowered down. Accordingly to the estimation of a famous wind energy consultant company, the short-term wind energy prediction can bring the benefit of 7 Euros per million watt hour (MWH) by considering a single wind farm in Spain. Of course, the combination prediction of plural wind farms can be more precisely and get more benefit. Therefore, many countries are devoted to the wind energy prediction system and technology to enhance the business efficiency of wind farms.

Taiwan is an island nation located in the western Pacific Ocean. Taiwan suffers many typhoons every year, and besides, the undulation of Taiwan's landform varies a lot, with more than 100 mountains higher than 3000 meters. Therefore, the track and strength of the typhoon always varies capriciously when typhoons pass through Taiwan. Typhoons had destroyed a lot of wind turbines in Taiwan. Different kinds of wind turbines designed to against different levels of strength of the wind speed, if the extreme wind speed exceeds the upper limitation of the wind turbine, the security problem of the wind turbine will occur.

Therefore, it is a very important subject to provide a wind energy forecasting method with extreme wind speed prediction function that can provide wind energy prediction with considering the specific weather (e.g. typhoons, hurricanes, etc.) so as to improve the efficiency of wind power generation, and can predict the extreme wind speed of the typhoon when the typhoon comes so as to avoid the security problem of the wind turbines.

### SUMMARY OF THE INVENTION

In view of the foregoing subject, an objective of the invention is to provide a wind energy forecasting method with extreme wind speed prediction function that can make wind energy prediction so as to improve the usage efficiency of wind power generation, and can predict the extreme wind speed of the typhoon when it comes so as to solve the security problem of the wind turbines.

To achieve the above object, a wind energy forecasting method with extreme wind speed prediction function cooperated with a central computer includes the following steps of: inputting a weather data which contains a numerical weather prediction data, modifying with the first model output statistics, modifying with a physical model in accordance with the output of the first output statistics that can iteratively calculate the results by varying the angles of wind direction, modifying with the second model output statistics, and predicting the extreme wind speed caused by typhoon, which includes the following sub-steps of: using the wind and typhoon database to find the track data of the plurality of historical typhoons within a distance from the target typhoon, using the extreme wind and wind energy prediction tool to calculate at least one extreme wind speed of the target typhoon and then calculate the probability of occurring the extreme wind speed, modifying the extreme wind speed to the extreme wind speed at the position or height of wind turbine with the physical model and giving warning to wind farm operators.

In an embodiment of the invention, the central computer is installed with the extreme wind and wind energy prediction tool, the wind and typhoon database and a wind turbine database.

In an embodiment of the invention, the central computer receives data from at least one in-situ computer at the wind farm, and the numerical weather prediction data.

In an embodiment of the invention, the weather data further contains a wind monitoring data.

In an embodiment of the invention, the prediction result contains the extreme wind speed of a wind turbine at a wind farm.

In an embodiment of the invention, the wind and wind energy prediction tool includes a wind energy prediction module, or a wind turbine performance analysis module, or an extreme wind prediction module.

In an embodiment of the invention, the step of the prediction of damage caused by typhoon further includes determine the level of damage risk according to the extreme wind speed.

In an embodiment of the invention, the calculation of the probability of occurring the extreme wind speed is based on the following: the historical typhoons are at distances R1, R2, R3, . . . , RN from the target typhoon respectively, the target typhoon can obtain the effect of the extreme wind speed from the historical typhoons respectively by the probabilities 1/R1, 1/R2, 1/R3, . . . , 1/RN, and if making Σ=(1/R1+1/R2+1/R3 . . . +1/RN γ100, the probabilities of occurring extreme wind speed of the historical typhoons will be Σ/R1, Σ/R2, Σ/R3, . . . , Σ/RN, respectively.

In an embodiment of the invention, the method further includes generating a prediction result and releasing the prediction result.

In an embodiment of the invention, the central computer has a forecasting database in which the prediction result is stored.

As mentioned above, the wind energy forecasting method with extreme wind speed prediction function implements the iterative calculation of different angles of wind direction according to the wind direction prediction uncertainty of the numerical weather prediction and the first model output statistics, so that the prediction can cover the variation and probability of the wind energy output caused by the change of the wind direction, so as to achieve the purpose of ensemble forecasting of wind energy. Besides, to deal with the influence of typhoon on the wind turbine, the method of the invention can implement analysis according to the typhoons' historical data and their tracks to predict the extreme wind speed and establish warning mechanism to respond possible damage risk so as to secure the wind turbine. Furthermore, the wind turbine performance analysis module of the invention can do the performance analysis of wind speed and power output of the wind turbine to output the wind turbine performance curve as the reference for adjusting wind turbine performance curves and arranging the schedule of wind turbine maintenance.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flowchart diagram of a wind energy forecasting method with extreme wind speed prediction function of a preferred embodiment of the invention;

FIG. 2 is a block diagram of a central computer cooperated with the wind energy forecasting method of the preferred embodiment of the invention;

FIGS. 3A to 3C are diagrams showing the data of the wind energy forecasting method of the preferred embodiment of the invention; and

FIG. 4 is a block diagram of another central computer cooperated with the wind energy forecasting method of the preferred embodiment of the invention.

### DETAILED DESCRIPTION OF THE INVENTION

The present invention will be apparent from the following detailed description, which proceeds with reference to the accompanying drawings, wherein the same references relate to the same elements.

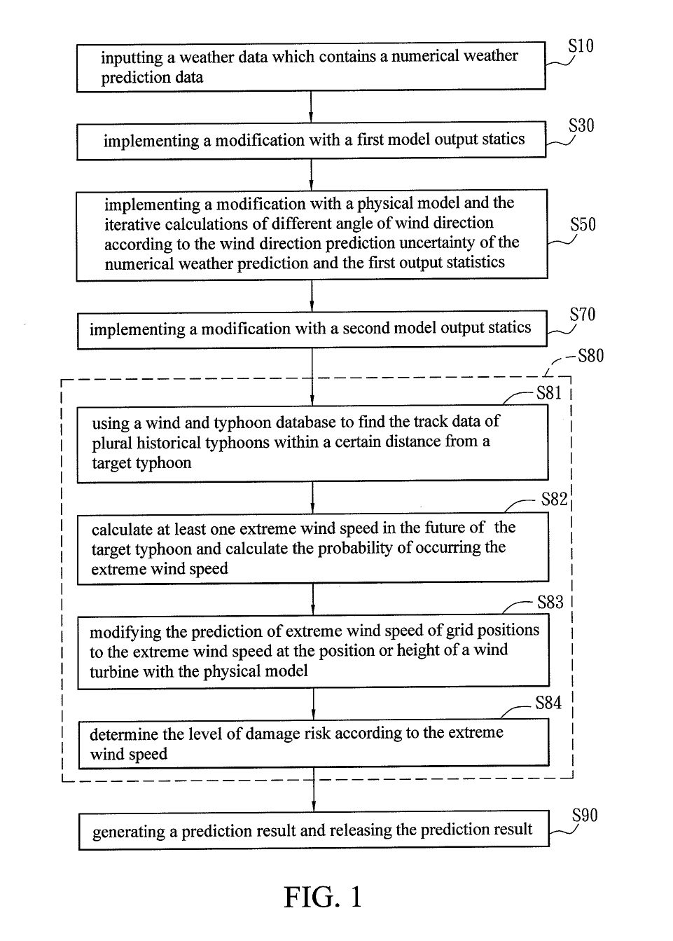

FIG. 1 is a flowchart diagram of the wind energy forecasting method with extreme wind speed prediction function according to a preferred embodiment of the invention. As shown in FIG. 1, the wind energy forecasting method with extreme wind speed prediction function cooperated with a central computer includes the following steps of inputting a weather data which contains a numerical weather prediction data (S10), implementing a modification with a first model output statistics (MOS) (S30), implementing a modification with a physical model and the iterative calculations of different angle of wind direction according to the wind direction prediction uncertainty of the numerical weather prediction and the first model output statistics, so that the prediction can cover the variation and probability of the wind energy output caused by the change of the wind direction (S50), implementing a modification with a second model output statistics (S70), and implementing a prediction of damage caused by typhoon (S80). The step S80 includes the following sub-steps of using a wind and typhoon database to find the track data of plural historical typhoons within a certain distance from a target typhoon (S81), using an extreme wind and wind energy prediction tool (EWWEPT) (11) to calculate at least one extreme wind speed of the target typhoon and calculate the probability of occurring the extreme wind speed (S82), and modifying the prediction of extreme wind speed of grid positions to the extreme wind speed at the position or height of a wind turbine with the physical model (S83). The details of the above steps are described below.

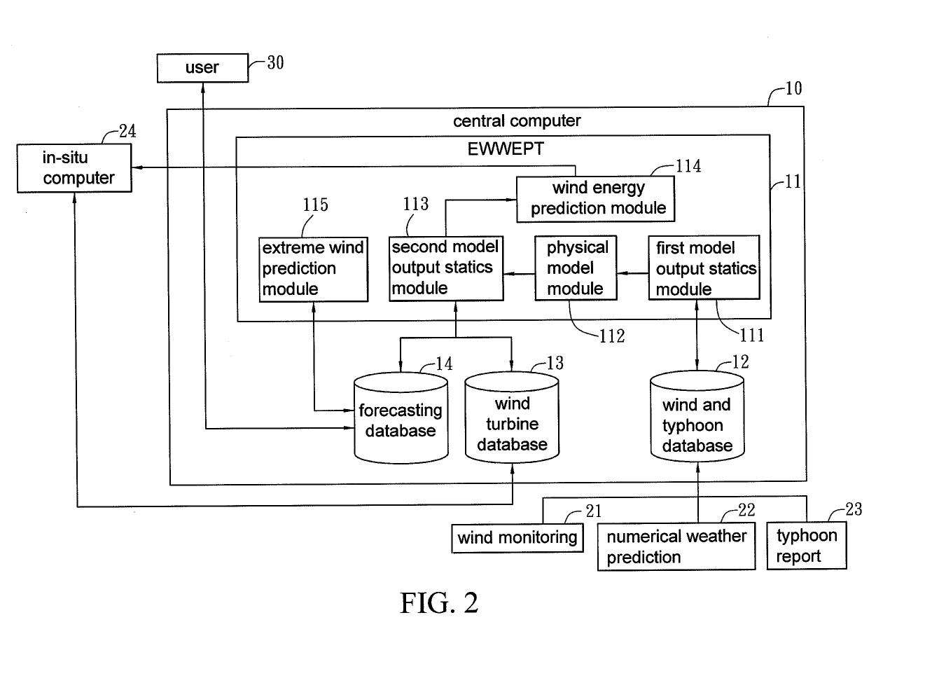

FIG. 2 is a block diagram of the central computer cooperated with the wind energy prediction method of the embodiment. The central computer 10 has the EWWEPT 11, a wind and typhoon database 12, a wind turbine database 13 and a forecasting database 14, and has an interface that can receive the data from the wind monitoring 21, the numerical weather prediction (NWP) 22, the typhoon report 23 and the in-situ computers 24.

The central computer 10 can operate the EWWEPT 11, release the report of extreme wind speed and wind energy prediction to the user 30, and store the result in the forecasting database 14. The user 30 may be an operator of the wind farm, a manager of power transmission and distribution, or a stakeholder of the electricity market.

The EWWEPT 11 includes a first model output statistics module 111, a physical model module 112, a second model output statistics module 113, a wind energy prediction module 114 and an extreme wind prediction module 115.

The wind and typhoon database 12 stores the weather data of the in-situ computer 24 and the wind monitoring station. The weather data contains the data of the wind monitoring 21, the wind data predicted by the numerical weather prediction 22, and the data of the typhoon report 23. The data of the wind monitoring 21 includes, for example, the monitoring result provided by the weather vane, the Doppler radar, and the laser radar. To be noted, the numerical weather prediction 22 is a conventional method of weather prediction, in which the numerical data acquired by the observations of radiosondes, radars, ships, satellites or the like is used to solve the equations of fluid dynamics and thermodynamics describing the weather development to predict the future weather. The typhoon report 23 can be made by various institutions, which relates to the data of typhoon position and strength and the original wind map data provided by the weather institution. The typhoon position and strength data includes the time and position of the modified track of typhoon and the highest wind speed of the typhoon center. The wind map data includes the normalized wind speed data of the ground grid points which are corresponding to the positions of the track of the typhoon at the same time. The original wind speed data of the ground grid points comes through the digitalization of the typhoon track and wind speed distribution diagram. No matter where the typhoon moves, the ground grid points are stationary, and for every typhoon at a certain time and a certain position, there is a wind speed distribution diagram that is relative to the ground and can be digitalized. Hence, every ground grid point corresponding to the track position of every typhoon has the wind speed data, and the normalized wind speed data can be obtained by the highest wind speed of the typhoon center divided by the wind speed of the wind speed data.

The wind turbine 13 stores the information from the in-situ computer 24 related to the wind turbines in local wind farms, and the information may contain the wind turbine position, wind speed, power output, operation time, wind turbine specification for the tolerance of wind speed, and maintenance record of the wind turbine.

Referring to FIGS. 1 and 2, the following is the detailed description of the wind energy forecasting method with extreme wind speed prediction function. At first, in the step S10, the central computer 10 receives a set of weather data which contains a set of data of the numerical weather prediction 22, and the weather data is transmitted to the EWWEPT 11 for data collection. The weather data can further contain a set of data of wind monitoring 21 which is promptly received by the central computer 10 and transmitted to the EWWEPT 11 for data collection.

In the step S30, the first model output statistics module 111 of the EWWEPT 11 implements a modification of wind speed and direction with a first model output statistics. The first model output statistics module 111 uses the numerical weather prediction 22 data and wind monitoring 21 data stored in the wind and typhoon database 12 to modify the wind speed and wind direction at the required height of the specific ground grid point for the wind energy prediction at each of the wind farm with a statistics model. In general, the numerical weather prediction 22 updates its prediction every 12 hours. By adding the practical wind monitoring 21 data, the prediction accuracy can be enhanced, and besides, the prediction can be updated in a shorter time, for example one time per ten minutes, so as to increase the update frequency.

In the step S50, the physical model module 112 of the EWWEPT 11 receives the data of wind speed and wind direction modified by the first model output statistics module 111, and modifies the modified wind speed data to that at the position and height of the wind turbine by the calculation according to the land topography, land roughness and obstacle model established in the physical model module 112. In general, the wind direction acquired by the prediction or monitoring is simplified to show only one angle, for example the north or north-northeast in the condition of eight wind directions or sixteen wind directions, however a certain level of inaccuracy exists here. So, the physical model module 112 of the invention can calculate wind direction in multi angles (for example, the angle of the original prediction or monitoring with the increment or decrement of one degree to fifteen degrees), so as to further derive the condition and probability of variation of the prediction caused by changes of the wind direction, to achieve the purpose of ensemble forecasting, keep the variation level of wind energy, and support wind turbine controlling and wind energy distribution strategy.

In the step S70, the second model output statistics module 113 inputs the historical data from the prediction and the practical output of wind turbine into the statistics model (e.g. nonlinear statistics model, such as back propagation artificial neural network (BP)) and hybrid genetic algorithm-BP neural networks (GABP) for beforehand training. Besides, the collection of prediction data and error data can be used periodically to adjust the parameters continuously so as to improve the accuracy of the wind energy prediction.

The step S80 is predicting damage caused by the extreme wind speed of typhoon. In the step S80, the extreme wind speed prediction module 115 can find the interested typhoons related to the target typhoon (such as the latest discovered typhoon or the typhoon needed to keep an eye on), and calculate the extreme wind speed during the typhoon invading period by the wind map data. In the embodiment, the step S80 can further includes the four sub-steps S81˜S84, as follows.

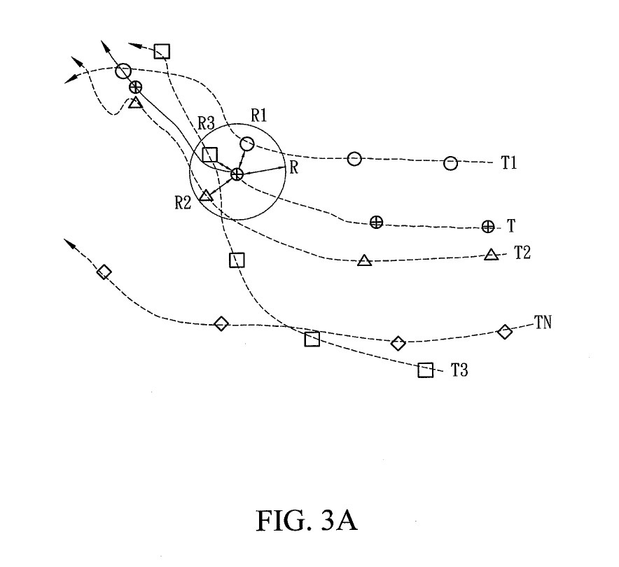

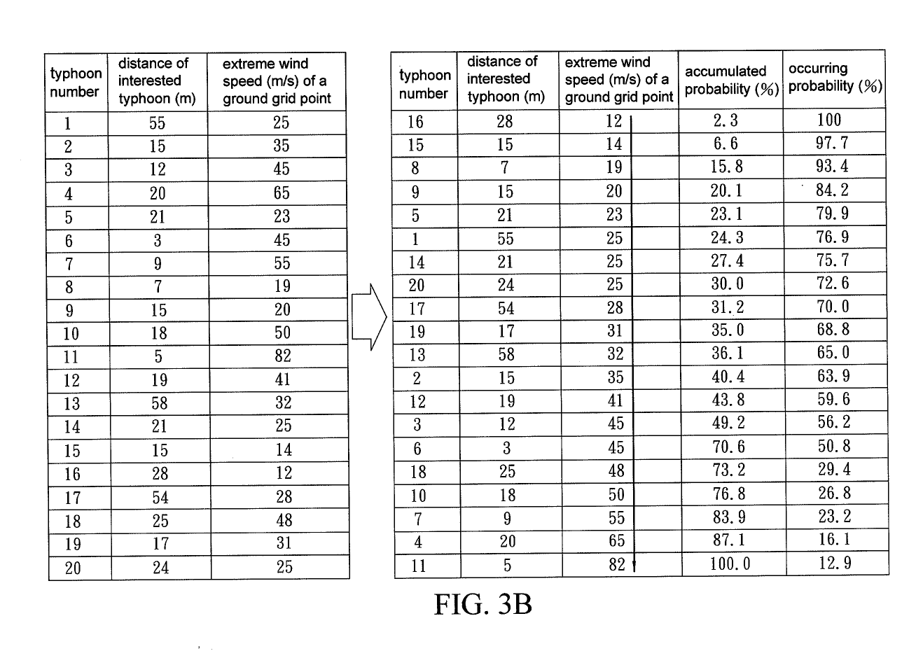

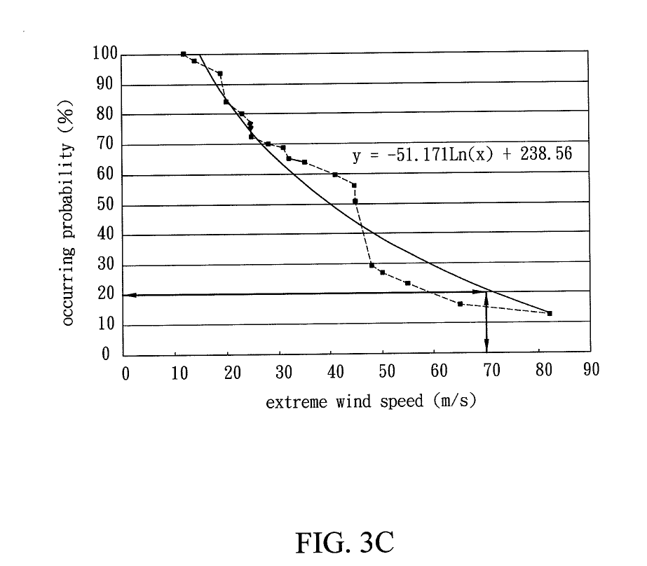

In the step S81, when the new typhoon warning is issued, the center position or the future position of the typhoon that is issued by the weather institution can be input into the extreme wind prediction module 115. Then, the issued typhoon is regarded as the target typhoon T, and an interested range is defined within a circle that has the center represented by the central position of the target typhoon T with the radius R. Because the tracks of typhoons are not completely the same, the interested range can help acquire the data of the typhoons close to the target typhoon T, resulting in the expansion of the data basis of the extreme wind estimation. As shown in FIG. 3A, the extreme wind prediction module 115 can find all the interested typhoons T1˜T3 ever entering into the interested range according to the position of the target typhoon T and the interested range. Subsequently, the extreme wind prediction module 115 can find normalized wind speed data of the ground grid points corresponding to the tracks of the interested typhoons T1˜T3.

In the step S82, as shown in FIG. 3A, the normalized extreme wind speeds of the interested typhoons T1˜T3 of each of the ground grid points are subsequently derived. Then, the maximums of the extreme wind speed of each of the ground grid points in accordance with the interested typhoons T1˜T3 are compared to obtain the normalized extreme wind speed of each of the ground grid points over the interested range, and the normalized extreme wind speed is converted to the extreme wind speed of each of the ground grid points on the basis of the practical or expected strength of the target typhoon T. Subsequently, by using the shortest distances R1˜R3 from the interested typhoons T1˜T3 to the target typhoon T, the probability of occurring the extreme wind speed calculated by the interested typhoons T1˜T3 is figured out. Afterward, the extreme wind speeds converted according to the interested typhoons T1˜T3 are sorted by value, and the probabilities are correspondingly accumulated, and thus the possibility of occurring the wind speed exceeding a certain level at each of the ground grid points can be derived.

FIGS. 3B and 3C show the probability calculation of occurring the extreme wind speed for a certain ground grid point in the interested range caused by 20 typhoons for example, and the probability can be calculated by the following method. The 20 typhoons are at distances R1, R2, R3, . . . , RN (N is 20 here for example) from the target typhoon respectively, while the farther interested typhoon can do less effect in the calculation of the probability of occurring the extreme wind speed of the target typhoon. So, here is an assumption that is the probability is in inverse proportion with the distance. Accordingly, the target typhoon T can obtain the effect of the extreme wind speed from the 20 typhoons respectively by the probabilities 1/R1, 1/R2, 1/R3, . . . , 1/RN. If making Σ=(1/R1+1/R2+1/R3 . . . +1/RN)/100, then the probabilities will be converted to percentages Σ/R1, Σ/R2, Σ/R3, . . . , Σ/RN, and the accumulation of the 20 percentages will be equal to 100 percent. Therefore, if the data is sorted by the way of decreasing progressively, the probability of the wind speed exceeding or equal to a certain level can be derived. Besides, the data can be used for making graph as shown in FIG. 3C in which the trend curve is added. To be noted, only the probabilities of occurring the extreme wind speed more than some certain wind speeds can be calculated.

In the step S83, the extreme wind speed of each of the ground grid points can be modified to the extreme wind speed at the position and height of the wind turbine by the physical model 112 to obtain the extreme wind speed of the actual position and height of the wind turbine.

In the embodiment, the wind energy forecasting method with extreme wind speed prediction function can further includes determine the level of damage risk according to the extreme wind speed (S84). As shown in FIG. 2, the EWWEPT 11 can obtain the specification for the tolerance of wind strength of the wind turbine from the wind turbine database 13, and compare that with the value and the probability of the extreme wind speed at the position and height of the wind turbine acquired from the step S83 to determine the damage risk caused by the extreme wind speed of typhoon. If the risk is larger than a predetermined level, a warning message will be sent to the user 30 and the in-situ computer 24 by the central computer 24. The risk can be divided into multi levels, such as a notice, an alarm or an emergency action. The warning message can be broadcasted through network or short message service (SMS) to the stakeholders. According to different models of the wind turbine and specifications for the tolerance of wind strength, proper operation plans of the wind turbine can be looked up to provide the user 30 as the decision strategy.

In the embodiment, the wind energy forecasting method with extreme wind speed prediction function can further include the step S90 of generating a prediction result and releasing the prediction result. After integrating the wind speed data at the position of the wind turbine modified by the physical model module 112, re-calculation can be implemented by the above statistics model to produce the extreme wind speed and the wind prediction result of the respective wind turbine or the wind farm. The prediction result includes the wind power output of each wind turbine of each wind farm, and the prediction results can be stored in a forecasting database 14 for the accuracy estimation of the prediction and for the training of the second model output statistics module 113. The prediction result can be released; for example, the wind energy prediction result is sent to the user 30 for the reference of operation, power distribution, maintenance, adjusting and shut down of the wind turbine so as to increase the efficiency and economic benefits of the wind farms or the wind turbines.

To be noted, the typhoon used in the invention means the violent tropical cyclone that is formed in the western part of the North Pacific Ocean and South Chine Sea. Such violent tropical cyclone is named differently in different areas. For example, it is called hurricane in the western part of the Atlantic, the Caribbean, the Gulf of Mexico, the eastern part of the North Pacific Ocean. Accordingly, the typhoon and hurricane are the different names due to the different areas, while the violent tropical cyclone is called typhoon in the invention just for example to make a description.

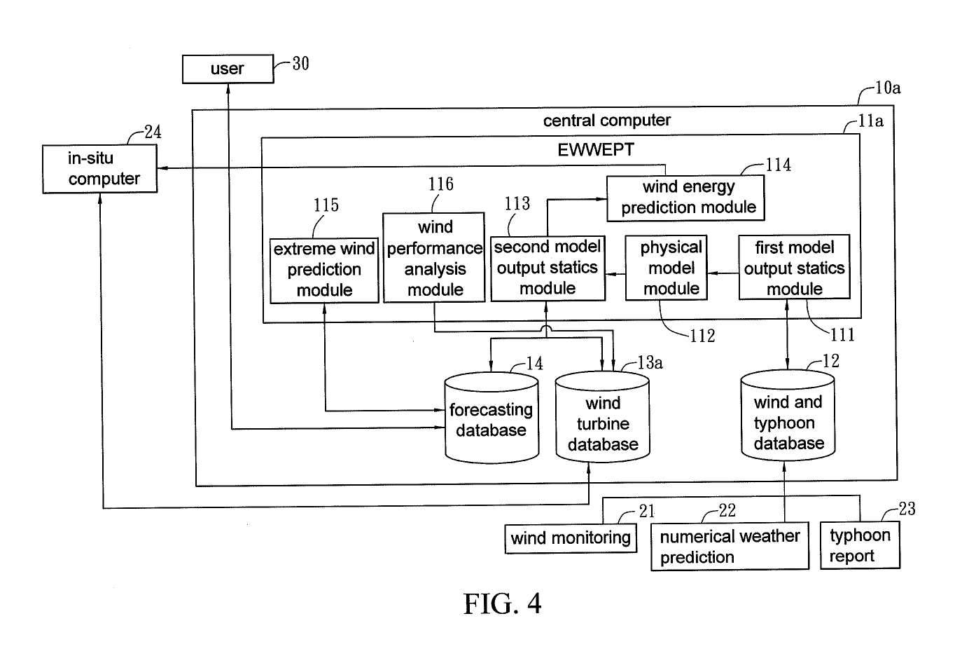

FIG. 4 is a diagram of another central computer cooperated with the wind energy forecasting method. Different from the structure of FIG. 2, the EWWEPT 11a of the central computer 10a of the embodiment further includes a wind turbine performance analysis module 116, and the wind turbine database 13a further has the current and historical performance curve of the wind turbine performance. The wind performance analysis module 116 can implement statistical analysis and edit the performance curve of respective wind turbine according to the wind speed data and wind power output data of the wind turbine stored in the wind turbine database 13a. The wind turbine performance curve of the wind turbine performance analysis module 116 and the wind turbine data acquired by the monitoring of the in-situ computer 24 are output and stored in the wind turbine database 13a.

The EWWEPT 11a predicts the power output of each wind turbine that just leaved the factory according to the default wind speed and default performance curve the power output of the wind turbine and the default prediction value of the wind speed. After a period of usage, the wind turbine performance analysis module 116 of the EWWEPT 11a can implement a statistical analysis of the wind speed data and the wind power output data of the wind turbine collected during the period of usage according to the practical observation data of the in-situ computer 24, to draw the newer and more practical performance curve of the wind speed and the power output of the wind turbine so as to improve the accuracy of wind energy forecasting. The historical data of wind turbine performance curves can be stored for the comparison with the latest data of wind turbine performance curves by the wind turbine performance analysis module 116, which can figure out the variation of the power output performance as the reference of the subsequent maintenance, update and error analysis. The analysis results above can be fed back to each wind farm through network.

In summary, the wind energy forecasting method with extreme wind speed prediction function implements the calculation of wind directions with multi angles by using the modified wind direction and wind speed with the statistics model, so that the prediction can cover the range of variation and probability of the wind energy output caused by the change of the wind direction, so as to achieve ensemble forecasting of wind energy and make the strategy of power distribution more reliable. Besides, to deal with the influence extreme wind speed of typhoon on the wind turbine, the method of the invention can implement analysis according to the typhoon track and historical data to predict the extreme wind speed and establish warning mechanism for damage risk so as to secure the wind power system. Furthermore, the wind turbine performance analysis module of the invention can make the performance analysis of power output of the wind turbine, and the analysis result can provides the user as the reference of variation estimation of power generating trend, instrument adjustment and maintenance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wind energy forecasting method with extreme wind speed prediction function cooperated with a central computer, comprising the steps of:
inputting a weather data which contains a numerical weather prediction data;
implementing a modification with a first model output statistics;
implementing a modification with a physical model in accordance with the output of the first model output statistics that can iteratively calculate the results by varying the angles of wind direction;
implementing a modification with a second model output statistics; and
implementing a prediction of extreme wind speed caused by typhoon, which comprises the following sub-steps of:
using a wind and typhoon database to find track data of plural historical typhoons within a certain distance from a target typhoon;
using an extreme wind and wind energy prediction tool to calculate at least one extreme wind speed in the future of the target typhoon and calculate the probability of occurring the extreme wind speed; and
modifying the extreme wind speed with the physical model to the extreme wind speed at the position or height of a wind turbine.

2. The wind energy forecasting method with extreme wind speed prediction function as recited in claim 1, wherein the central computer is installed with the extreme wind and wind energy prediction tool, the wind and typhoon database and a wind turbine database.

3. The wind energy forecasting method with extreme wind speed prediction function as recited in claim 1, wherein the central computer receives data from at least one in-situ computer at the wind farm, and the numerical weather prediction data.

4. The wind energy forecasting method with extreme wind speed prediction function as recited in claim 1, wherein the central computer has a forecasting database in which the prediction result is stored.

5. The wind energy forecasting method with extreme wind speed prediction function as recited in claim 1, wherein the weather data further contains a wind monitoring data.

6. The wind energy forecasting method with extreme wind speed prediction function as recited in claim 1, wherein the prediction result contains the extreme wind speed of a wind turbine at a wind farm.

7. The wind energy forecasting method with extreme wind speed prediction function as recited in claim 1, wherein the wind and wind energy prediction tool includes a wind energy prediction module, or a wind turbine performance analysis module, or an extreme wind prediction module.

8. The wind energy forecasting method with extreme wind speed prediction function as recited in claim 1, wherein the step of the prediction of damage caused by typhoon further includes determine the level of damage risk according to the extreme wind speed.

9. The wind energy forecasting method with extreme wind speed prediction function as recited in claim 1, wherein the calculation of the probability of occurring the extreme wind speed is based on the following:
the historical typhoons are at distances R1, R2, R3, . . . , RN from the target typhoon respectively, the target typhoon can obtain the effect of the extreme wind speed from the historical typhoons respectively by the probabilities 1/R1, 1/R2, 1/R3, . . . , 1/RN, and if making Σ=(1/R1+l/R2+1/R3 . . . +1/RN)/100, the probabilities of occurring extreme wind speed of the historical typhoons will be Σ/R1, Σ/R2, Σ/R3, . . . , Σ/RN, respectively.

10. The wind energy forecasting method with extreme wind speed prediction function as recited in claim 1, further comprising:
generating a prediction result and releasing the prediction result.
